(19) United States
(12) Patent Application Publication
(10) Pub. No.: US 2011/0103628 A1
(43) Pub. Date: May 5, 2011

(54) HEARING DEVICE AND METHOD FOR OPERATING THE SAME

(75) Inventor: Herbert Bachler, Meilen (CH)

(73) Assignee: PHONAK AG, Stafa (CH)

(21) Appl. No.: 12/999,838

(22) PCT Filed: Jun. 18, 2008
(86) PCT No.: PCT/EP08/57687

§ 371 Date: Dec. 17, 2010

(51) Int. Cl. H04R 25/00

(52) U.S. Cl. 381/323

(57) ABSTRACT

The invention refers to hearing devices (1) and methods of operating hearing devices (1). In one aspect, the hearing device (1) comprises a power supply unit (2) comprising a primary energy storing unit (3) and, in addition, a secondary energy storing unit (4). The power supply unit (2) is configured such that the secondary energy storing unit (4) is rechargeable by means of the primary energy storing unit (3). E.g., the primary energy storing unit (3) has a higher energy density than said secondary energy storing unit (4), and the secondary energy storing unit (4) has a lower internal resistance than said primary energy storing unit (3). This allows to provide electronic circuits (11;12;13;14) of the hearing device (1) with pulsed currents. In another aspect, the hearing device (1) comprises at least one processor (10;13;14), which is alternately operated in one of at least two operating modes. A first operating mode (A) is characterized by high processing activity and high power consumption, a second (B) by low or no processing activity and low or no power consumption. This allows to use of high-clock-frequency processors in a hearing device (1).

### TECHNICAL FIELD

The invention relates to the field of hearing devices, and more particularly to the power supply of hearing devices and/or to ways of operating a hearing device. It relates to methods and apparatuses according to the opening clauses of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

The power consumption of a hearing device is a continual problem. Usually, hearing devices are powered by Zn-air batteries. In order to maximize the lifetime of the battery, the power consuming processes in the hearing device are usually designed such that the power consumption is rather constant during operation of the hearing device.

In EP 1 473 968 A2, methods and apparatuses for supplying energy to a hearing device are disclosed. In particular, ways to achieve a particularly stable supply voltage even at deteriorating battery voltage, and ways to provide more than one stable supply voltage are disclosed.

It is desirable to provide an alternative way of managing the power consumption of a hearing device circuit.

### SUMMARY OF THE INVENTION

Therefore, one object of the invention is to create an alternative way of managing the power consumption of a hearing device circuit. In particular, hearing devices and methods for operating a hearing device shall be provided. In addition, a corresponding power supply and a use of a power supply shall be provided.

The inventor has found that there is an alternative to the power management conventionally implemented in hearing devices. Instead of trying to optimize the power consumption in a hearing device in such a way that it is low and—as far as possible—constant over time (typically in order to achieve a high lifetime of the conventionally used Zn-air batteries), it is also possible to employ a pulsed power consumption with high current peaks but periods of low or negligible power consumption therebetween, so as to achieve a low average power consumption, too. This way of dealing with the power consumption of a hearing device or of electronic circuits thereof can on the one hand be implemented using a particularly suited power supply unit and on the other hand involve a new—pulsed—operating mode of processors in hearing devices.

Accordingly, there are two main aspects to the invention. The first aspect is closely related to a power supply of a hearing device. The second aspect is closely related to the operation of processors in a hearing device.

One object of the invention in its first aspect is to provide an alternative way of supplying a hearing device circuit with energy.

One object of the invention in its first aspect is to provide an improved or simplified way to power an electronic circuit in a hearing device.

One object of the invention in its first aspect is to provide a way to reduce the space required for a power supply unit in a hearing device.

One object of the invention in its first aspect is to provide a way to power such kinds of electronic circuits in a hearing device, which otherwise could not be used in a hearing device.

One object of the invention in its second aspect is to provide a way to operate such kinds of electronic circuits in a hearing device, which otherwise could not be used in a hearing device.

One object of the invention in its second aspect is to provide an alternative way of operating electronic circuits, in particular processors, in a hearing device.

Further objects emerge from the description and embodiments below.

At least one of these objects is at least partially achieved by apparatuses, methods or uses according to the patent claims.

### First Aspect of the Invention:

According to the first aspect of the invention, the hearing device comprises a power supply unit comprising a primary energy storing unit and, in addition, a secondary energy storing unit, wherein said power supply unit is configured such that said secondary energy storing unit is rechargeable by means of said primary energy storing unit.

Accordingly, the power supply unit of the hearing device comprises two energy storing units, and energy drawn from said primary energy storing unit is used for charging said secondary primary energy storing unit.

This can be particulary advantageous when said primary and said secondary energy storing units have different properties. In that case, each of the energy storing units can be used for those purposes it is particularly well suited for.

In one embodiment, said hearing device comprises at least one electronic circuit, and the power supply unit is configured to provide said at least one electronic circuit with electric energy, i.e. to power (or feed) said at least one electronic circuit.

In one embodiment, said at least one electronic circuit is unrelated to said power supply.

The corresponding method for operating a hearing device comprising a power supply unit comprising a primary energy storing unit and, in addition, a secondary energy storing unit, comprises the step of recharging said secondary energy storing unit by means of said primary energy storing unit.

In one embodiment, said hearing device comprises at least one electronic circuit supplied with current drawn from said secondary energy storing unit.

It is possible to provide that said at least one electronic circuit is supplied solely with current drawn from said secondary energy storing unit, but it is also possible to provide that it is, in addition, also provided with current drawn from said primary energy storing unit. In the latter case, it is possible to provide that said at least one electronic circuit is alternatively provided with current drawn from either of the energy storing units, or, to provide that it is provided with current drawn from said primary energy storing unit and with current drawn from said secondary energy storing unit in an overlapping fashion.

It is possible to use said primary energy storing unit for meeting a base power consumption which can be approximately constant over time, and said secondary energy storing unit for meeting power consumption peaks.

In one embodiment, said secondary energy storing unit has a lower internal resistance than said primary energy storing unit. A lower internal resistance provides that a less pronounced voltage drop occurs when drawing a relatively high current. Accordingly, this allows to power (at the required voltage) an electronic circuit in a hearing device which needs a relatively high current. In particular, it can be possible to provide a current which cannot be generated at the required voltage by means of conventional hearing device power supplies, or at least not by such conventional hearing device power supplies which are sufficiently small to fit in an in-the-ear, in-the-canal or completely-in-the-canal device. Note that the internal resistance is in general an internal AC resistance (impedance), i.e. comprises not only an ohmic resistance, but also an inductance and—usually more importantly—a capacitance.

In one embodiment, said internal resistance of said secondary energy storing unit is lower by at least a factor of two or even four; in particular at direct current and/or at AC frequencies of 100 Hz or less.

In one embodiment, said primary energy storing unit has a higher energy density than said secondary energy storing unit. A high energy density, i.e. a large amount of energy storable per volume, is important for use in hearing devices, because of their small size and since it is inexpedient to introduce new energy into the hearing device very often, be it by inserting a new energy storing unit or by charging an energy storing unit in the hearing device from the outside.

In one embodiment, said energy density of said primary energy storing unit is higher by at least a factor of 1.5 or even two or even 2.5.

In one embodiment, said power supply unit is configured such that said secondary energy storing unit is recharged before it looses more that 25% of its full charge, in particular before it looses more than 15% of its full charge. Recharging an energy storing unit when it still has a considerable amount of its full charge can considerably prolong the lifetime of the energy storing unit. In other words, discharging the secondary energy storing unit only a little bit before recharging it again can massively contribute to a long lifetime of the secondary energy storing unit. Said “full” charge refers to its present status during its life cycle.

In one embodiment, said secondary energy storing unit is a capacitor. A capacitor can store electrical energy and can be discharged very quickly, so as to allow to draw relatively high currents at a stable voltage; note that “discharging” does not solely mean fully discharging. In particular, the capacitor can be a so-called ultracapacitor or super capacitor or double-layer capacitor.

In one embodiment, said primary energy storing unit is a battery. The battery can be a rechargable or a not rechargable battery.

In one embodiment, said primary energy storing unit is to be regularly replaced by the user of the hearing device.

In one embodiment, said primary energy storing unit is to be regularly recharged from the outside of the hearing device by the user.

In one embodiment, said secondary energy storing unit is a thin-film battery, in particular a thin-film alkali metal battery.

In one embodiment, said secondary energy storing unit comprises a rechargable thin-film Lithium battery (TLB). Batteries of this type are today commercially available and are capable of providing relatively high currents at quite stable voltage while having a long lifetime in terms of being rechargable many times such as of the order of 10,000 times or 100,000 times; in particular if partially discharged by only a small amount, even of the order of 1,000,000 times or more.

In one embodiment, said power supply unit comprises a voltage converter, and said secondary energy storing unit has a voltage different from, in particular higher than, the voltage of said primary energy storing unit. By said voltages of the primary energy storing unit and the secondary energy storing unit, respectively, of course, their normal, nominal voltages are meant. E.g., looking at the example first energy storing unit is a Zn-air battery and second energy storing unit is a TLB, electronic circuits—such as wireless transmitters and/or receivers and flash memory circuits—which require a higher voltage such as of about 3.6 V could be powered by the TLB, whereas other electronic circuits of the hearing device needing about 1.2 V could be powered by the Zn-air battery.

In one embodiment, the hearing device comprises at least one electronic circuit, wherein said power supply unit is configured to power said at least one electronic circuit, and wherein said electronic circuit comprises at least one of
a wireless transmitting and/or receiving circuit;
a signal processing circuit;
a controlling circuit;
a memory circuit.

Said wireless transmitting and/or receiving circuit can be a wireless transmitter/receiver/transceiver based on at least of the following technologies: Bluetooth, Wibree, ultra-wide band (UWB), GSM, UMTS, WLAN. Wibree is an interoperable radio technology for small devices, meant to offer connectivity between mobile devices or personal computers, and small, button cell battery powered devices, cf. http://www.wibree.com or http://www.bluetooth.org, as the Wibree specification apparently will be or become part of the Bluetooth specification as an ultra low power Bluetooth technology.

In one embodiment, said signal processing circuit is a digital signal processing circuit.

In one embodiment, said memory unit comprises a multitude of flash memory cells. Flash memory typically requires relatively high currents for writing, which make their application in conventional hearing device problematic.

In one embodiment, the hearing device comprises at least one electronic circuit, wherein said power supply unit is configured to power said at least one electronic circuit, and wherein the current drawn by said at least one electronic circuit is a pulsed current. In one embodiment, the corresponding current pulses are provided solely by said secondary energy storing unit to said at least one electronic circuit, i.e. during provision of such a current pulse by said secondary energy storing unit to said at least one electronic circuit, no electrical current flows from the primary energy storing unit to said at least one electronic circuit. A pulsed operation—which has a pulsed current consumption as a consequence—is a preferred way of operating certain kinds of electronic circuits such as flash memory or wireless transmitters/receivers, in particular UWB transmitters/receivers; but it can also be applied to processors such as digital signal processors or controllers, as will be discussed in more detail below in the second aspect of the invention.

In one embodiment, the hearing device comprises at least one other electronic circuit, wherein said power supply unit is configured to power said at least one other electronic circuit, and wherein the current drawn by said at least one other electronic circuit is a substantially constant current (DC current). In one embodiment, that DC current is provided solely by said primary energy storing unit to said at least one other electronic circuit, i.e. during provision of such a DC current by said primary energy storing unit to said at least one other electronic circuit, no electrical current flows from the secondary energy storing unit to said at least one other electronic circuit.

The power supply unit for a hearing device comprises, according to the first aspect of the invention, a primary energy storing unit and, in addition, a secondary energy storing unit, wherein said power supply unit is configured such that said secondary energy storing unit is rechargeable by means of said primary energy storing unit.

The use according to the invention is a use of a power supply unit comprising a primary energy storing unit and, in addition, a secondary energy storing unit, for powering an electronic circuit of a hearing device, wherein said power supply unit is configured such that said secondary energy storing unit is rechargeable by means of said primary energy storing unit.

### Second Aspect of the Invention:

According to the second aspect of the invention, the hearing device comprises at least one processor, which is alternately operated in one of at least two operating modes, a first of said at least two operating modes being characterized by high processing activity, a second of said at least two operating modes being characterized by low or no processing activity.

The corresponding method of operating a hearing device comprising at least one processor is characterized by alternately operating said at least one processor in one of at least two operating modes, a first of said at least two operating modes being characterized by high processing activity, a second of said at least two operating modes being characterized by low or no processing activity.

Said at least one processor can be considered to be operated in a pulsed fashion, with the consequence of a pulsed current consumption; in contrast to operating processors with a rather constant processing activity and power consumption, as it is preferred in the state of the art.

The invention can make it possible to use a standard processor instead of a customized processor. For example, a digital signal processor with a standard DSP architecture readily available in the market can be used, thus rendering the development of a customized and typically more complicated DSP architecture superfluous. A relatively fast-clocked standard processor operated in a pulsed fashion can be used instead of a relatively low-clocked ultra-low-power-consumption-optimized customized processor.

In one embodiment, in which the processing activity in said second mode is not zero, the ratio of processing activity in said second mode to processing activity in said first mode is at most 1:10, at most 1:50, at most 1:100 or even at most 1:500. The ratio of power consumptions or drawn currents are basically identical with these ratios of processing activity.

In one embodiment, the hearing device is operated such that said at least one processor is operated in said first mode for at most 25% of the time, in particular at most 10%, at most 15%, at most 5%, at most 1% or even at most 0.2% of the time—on the average. Depending on the application, it is possible that said at least one processor is operated in said first mode for at most 0.1% or at most 0.05% of the time.

In one embodiment, the hearing device is operated such that said at least one processor is operated in said first mode for at most 50 ms, in particular most 10 ms, most 5 ms or even at most 1 ms before switching to another mode. In one embodiment, it is operated in said first mode for between 0.05 ms and 100 ms before switching to another mode.

In one embodiment, said at least one processor is operated such that switching from said first mode to another of said modes occurs generally periodically.

In one embodiment, while operated in said first mode, said processor draws a peak current of at least 5 mA.

In one embodiment, said peak current is at least 10 mA.

In one embodiment, said peak current is at least 20 mA.

In one embodiment, said peak current is at least 40 mA.

In one embodiment, said at least one processor comprises a digital signal processor.

In one embodiment, said at least one processor comprises a micro-controller.

Of course, the above-described two aspects of the invention can be combined and used together, e.g., in the sense that the mode of operating a processor as depicted in the second aspect is used in a hearing device comprising a power supply unit as depicted in the first aspect. The corresponding secondary energy storing unit could be used for powering the processor at least while it is operated in the first mode.

The advantages of the methods and uses correspond to the advantages of corresponding apparatuses and vice versa.

Further embodiments and advantages emerge from the dependent claims and the figures.

### BRIEF DESCRIPTION OF THE DRAWINGS

Below, the invention is described in more detail by means of examples and the included drawings. The figures show:

FIG. 1 a schematic diagram of a hearing device and a method;

FIG. 2 a graph of a load current;

FIG. 3 a block diagram of a power supply unit, schematically;

FIG. 4 the power supply unit of FIG. 3, illustrating a charging process;

FIG. 5 the power supply unit of FIGS. 3 and 4, illustrating the supply of a pulsed current;

FIG. 6 an illustration of a voltage supply with internal resistance;

FIG. 7 a graph of a load current, schematically;

FIG. 8 a graph of a supply voltage at low internal resistance, schematically;

FIG. 9 a graph of a supply voltage with high internal resistance, schematically.

The reference symbols used in the figures and their meaning are summarized in the list of reference symbols. The described embodiments are meant as examples and shall not confine the invention.

### DETAILED DESCRIPTION OF THE INVENTION

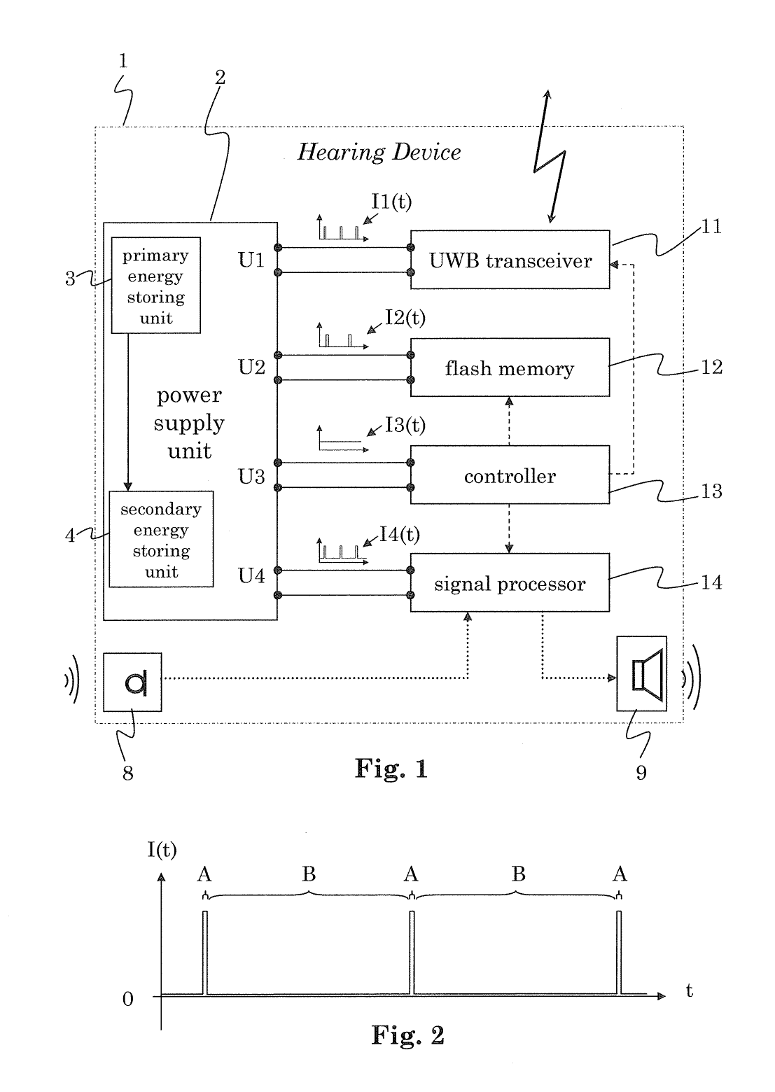

FIG. 1 shows a schematic diagram of a hearing device 1 and illustrates a method of operating a hearing device 1. The hearing device 1 comprises a power supply unit 2, an input unit 8, an output unit 9 and electronic circuits 11,12,13,14, e.g., an ultra wide band (UWB) transceiver 11, a memory unit 12, a controller 13 and a signal processing unit 14. The basic function of hearing device 1 is only roughly depicted in FIG. 1: In input unit 8, acoustic sound is converted into electrical signals, which are processed in signal processor 14 and then converted into signals to be perceived by a user of the hearing device 1, typically acoustic sound.

Controller 13 controls the other circuits 11,12,14 of the hearing device 1. Further standard functions and components of hearing device 1 which are not shown in FIG. 1, are known in the art.

The power supply unit 2 supplies the electronic circuits 11,12,13,14 with supply voltages U1, U2, U3, U4 and comprises two energy storing units 3 and 4, which store electrical energy and function as energy sources. E.g., energy storing unit 3 can be a battery, e.g., a Zn-air battery, and energy storing unit 4 can be a thin film Lithium battery (TLB). Energy storing unit 4 can be recharged by energy storing unit 3, as will be discussed in greater detail below.

The supply voltages U1, U2, U3, U4 are typically of the order of 1 V to several volts and can (nominally) be the same, e.g., about 1.2 V as provided by a Zn-air battery. But it is also possible to provide different supply voltages U1, U2, U3, U4, e.g., U1 and U2 about 3.6 V as provided by a thin film Lithium battery (TLB), but U3 and U4 about 1.2 V as provided by a Zn-air battery. In FIG. 1, the current-versus-time graphs of exemplary currents I1(t), I2(t), I3(t), I4(t) drawn by the circuits 11,12,13,14 are schematically depicted. Current I3(t) is substantially constant over time, whereas I1(t),I2(t),I4(t) show a pronounced time dependence, namely in form of pulses. Currents I1(t), I2(t) are substantially zero between successive pulses and have a duty cycle of less than 1:1,whereas I4(t) provides a non-zero current between successive current maxima.

The assignment of the indicated load currents I1(t),I2(t),I3(t),I4(t) to the depicted electronic circuits is only exemplary; the circuitries could also be operated differently. E.g., signal processor 14 could also be operated using a generally constant current, or controller 13 could be operated using a pulsed current, or pulsed currents could have different time dependencies.

Flash memory, though, requires, during writing of many cells, relatively high currents, while not in need of current otherwise. And UWB transceiver 11 needs relatively high currents only during sending and receiving.

FIG. 2 shows a graph of an exemplary load current I(t), in particular of a pulsed current.

The current peak of load current I(t) can be of the order of 1 mA, of the order of 10 mA or even as high as of the order of 100 mA. Between successive current peaks, I(t) is approximately constant at a low current. If a processor such as a controller 13 or signal processor 14 (cf. FIG. 1) is operated so as to show a current consumption I(t) according to FIG. 2, the processor could be considered to be operated in a switched fashion, operated alternately in one of two modes, wherein in a first mode the processor has a high processing activity and, accordingly, a high current consumption, and in a second mode, a low processing activity and, accordingly, a low current consumption. In FIG. 2, phases in said first mode are labelled “A”, and phases in said second mode are labelled “B”. In said second mode (B), for example, processes and functions can be carried out which cannot be postponed until the next first mode phase (A).

Operating a processor in such a switched fashion is distinctly different from an operation in which an approximately constant processing activity and a correspondingly approximately constant power consumption is attempted to be achieved. A consequence of such a switched operation of a processor is, that for achieving the same average processing activity, the clock frequency or operating frequency of the processor operated in said switched fashion has to be much higher than in case of a processor drawing an approximately constant current.

Accordingly, a processor operating at a higher frequency will be used, and—fortunately—such processors are readily commercially available, even easier than processors used nowadays in hearing devices. E.g., instead of a frequency of a couple of Megahertz, clock frequencies of the order of 100 MHz or more would be used for operating the processor.

The duty cycle of the pulsed current of FIG. 2 is approximately 1:50. Note that we use the term “duty cycle” in this application not solely in cases in which the current between two peaks is exactly zero, but also in cases as shown in FIG. 2, in which the current between two peaks is only a small fraction of the peak current. Depending on an electronic circuit to be powered and on the power supply unit, more particularly the energy storing unit or units, the duty cycle can be below or equal to 1:100, below or equal to 1:500, below or equal to 1:2000 and even lower; or the duty cycle can be below or equal to 1:4, 1:5, 1:10 or 1:20, e.g., for UWB transmitters and/or receivers, and/or when phase A is below or equal to 50 ns 20 ns or 10 ns, but—typically—above 0.1 ns. It turned out that in particular in case of such relatively high duty cycles and short durations of the phase A, a condensor can well be used as a secondary storage unit 4 or as a part thereof. Typically, the duty cycle is not below 1:2000, 1:5000 or 1:10000.

The load current can be substantially periodic or show no or only little periodicity. The load current can have a fourier transform having a non-zero component at 0 Hz. The load current can be a pulsed direct current (pulsed DC). The shape of the current peak can be different from an approximately rectangular shape as shown in schematical FIG. 2, e.g., asymmetric or irregular.

An important motivation for using a particular sort of power supply unit 2 in a hearing device, is that there are electronic circuits such as flash memory chips or wireless transmitters and/or receivers, which could be useful in a hearing device, but which occasionally or regularly require relatively high currents, e.g., above 10 mA or 30 mA. With the exception perhaps of 675-size batteries, Zn-air batteries conventionally used in hearing devices are not capable of providing such currents at a sufficiently stable voltage. But 675-size batteries are so large that they fit in behind-the-ear hearing devices only.

On the other hand, due to the very limited space available in a hearing device, the amount of energy storable in the hearing device is very limited, so that a low average power consumption has to be achieved. At high currents, this is possible when using a power supply with a sufficiently low internal resistance.

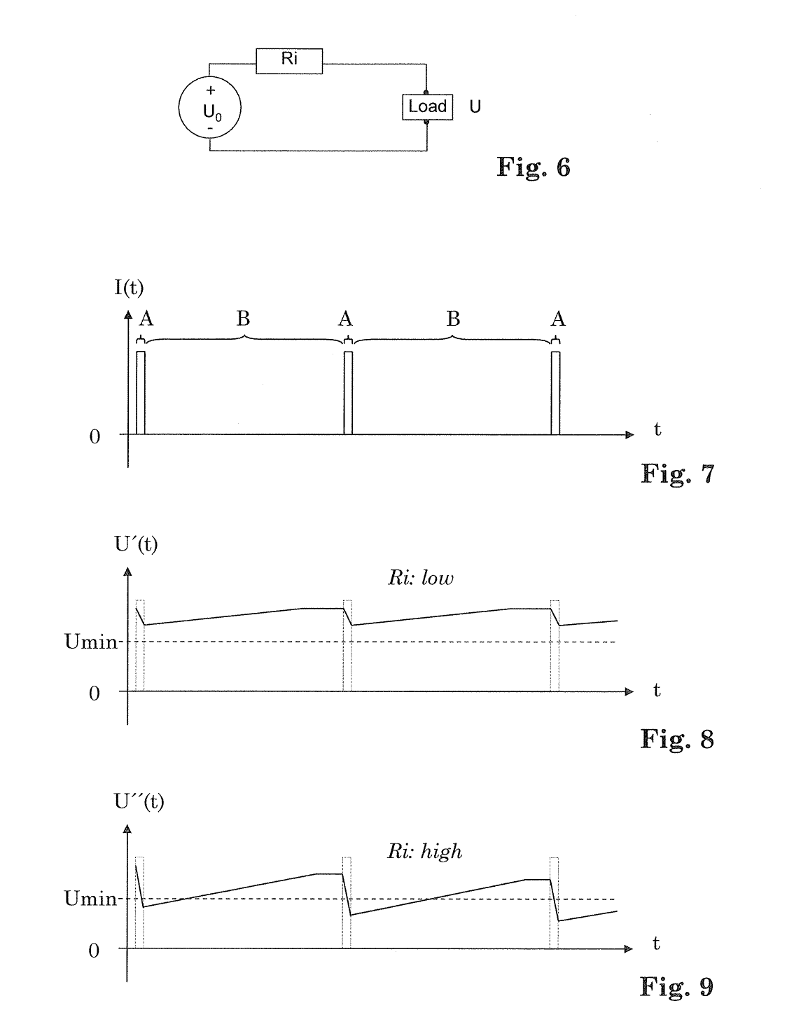

FIG. 6 is an illustration of a voltage supply with internal resistance, more precisely an equivalent circuit diagram of a real voltage supply. Every real voltage supply (power supply), such as a battery, has an internal resistance Ri, which results in a voltage drop when a load draws current from the voltage supply. I.e., when loaded, the voltage U will be lower than the unloaded voltage U₀ of the power supply. Note that in general, the internal resistance is an impedance comprising ohmic resistance, capacitance and inductivity.

There are several types of energy storing units, which are capable of providing suitably high currents at a sufficiently stable voltage, e.g., capacitors, thin film Lithium batteries (TLB). These have furthermore the advantage that they can be recharged, even very many times. For example, there is a commercially available TLB referred to as LS101 of the Lite*Star (™) brand of Infinite Power Solutions, Inc. (http://www.infinitepowersolutions.com), which works at about 4.0 V and has a power capacity of 0.7 mAh at a size of 25.4 mm times 25.4 mm times 0.11 mm. A TLB of much smaller size already, e.g., only 5 mm times 5 mm times 0.11 mm, corresponding to about 25 mF, would be largely sufficient for generating peak currents of about 20 mA for a 1 ms duration at a sufficiently stable voltage. Using such a TLB for powering an electronic circuit of a hearing device with a pulsed current having a duty cycle of 1:1000, there would be about 1 s time for recharging the TLB after each pulse. Uncharging energy storing units like such TLB to only a small amount, e.g., by only 10% or 20%, prolongs very much their lifetime in terms of recharging cycles. Furthermore, it can be advantageous to provide rather long time durations for charging, because this means that the charging currents are small. Such small currents could even be handled by capacitors which could even be provided on-chip with other circuitry of the hearing device, e.g., on the same chip as a signal processor or a controller.

There are energy storing units, e.g. TLBs, which can be made such that they are very flat or sheet-like in shape, possible even flexible. Such flat energy storing units are very suitable to be placed in the housing of a hearing device, e.g., close to the inside of the housing, or even forming the hearing device housing or a part of it.

It would be possible to provide that an energy storing unit (such as a TLB) that is recharged by another energy storing unit of the hearing device (such as a Zn-air battery) is replacable by the hearing device manufacturer or by a service person in case it would be used up, perhaps after several months or years.

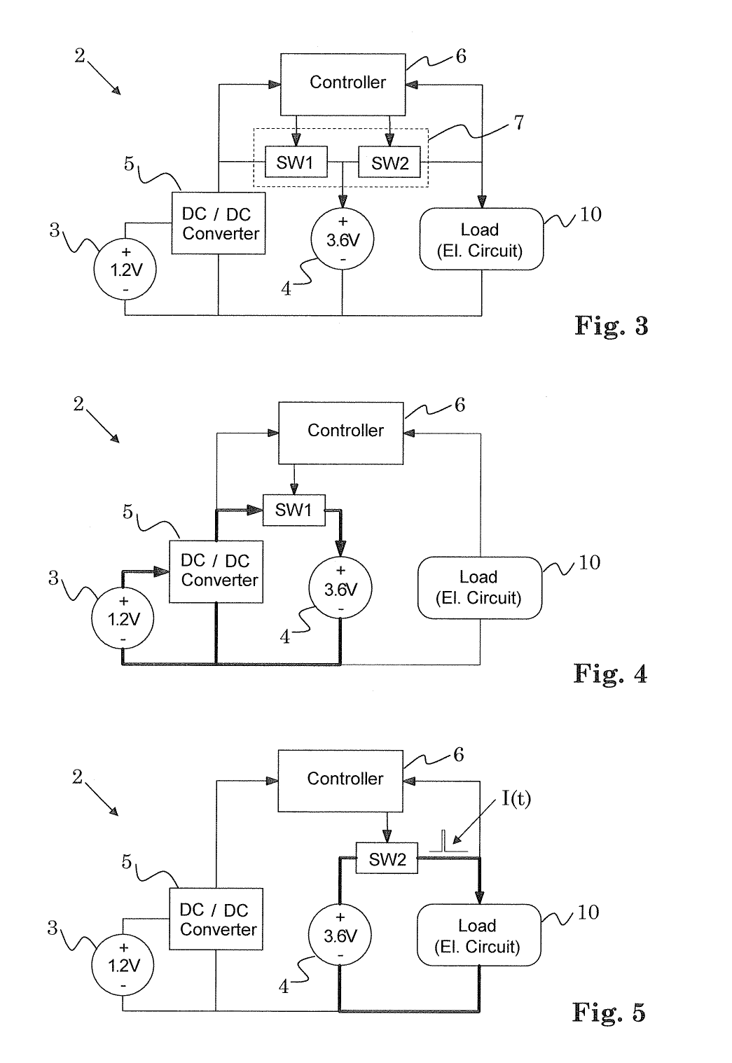

FIG. 3 is a block diagram schematically illustrating a power supply unit 2. The power supply unit 2 comprises two energy storing units 3 and 4, a voltage conversion unit 5, a control unit 6 and a switching unit 7. As illustrated in FIG. 3, the power supply unit 2 is used for powering a load 10, more particularly an electronic circuit, e.g., one or more of the electronic circuits depicted in FIG. 1. The voltage conversion unit 5 is required only in case that the two energy storing units 3 and 4 run at different voltages, as it is the case in FIG. 3. Otherwise it can be omitted. Ways of realizing suitable voltage converters are known in the art, e.g., from EP 1 473 968 A2; step-up capacitive DC/DC converters.

Energy storing unit 3 is used for recharging energy storing unit 4. For example, energy storing unit 3 can be a conventional battery such as a Zn-air battery having about 1.2 V, while energy storing unit 4 can be a rechargeable battery having about 3.6 V or a TLB as mentioned above having about 4 V or a capacitor. It is possible to provide two or more rechargeable energy storing units charged by another energy storing unit, e.g., one Zn-air battery charging a TLB and one or more capacitors.

The combination of a Zn-air battery as an energy storing unit 3 and a TLB as an energy storing unit 4 is particularly advantageous, since the first has a relatively high energy density while suffering from a relatively high internal resistance, and the latter has a very relatively low internal resistance while providing a relatively low energy density (typically only 0.2 to 0.1 times the energy density of a Zn-air battery). Furthermore, standard circuits and chips for wireless receiving/transmitting/transceiving readily commercially available work at voltages between 3 and 4 Volts (e.g., 3.3V), e.g., circuits and chips used in standard Bluetooth technology.

The controller 6 of the power supply unit 2 controls important portions of the operation of the power supply unit 2, in particular the charging of energy storing unit 4 and the providing of a supply voltage and a pulsed current to load 10. For this purpose, controller 6 controls in particular switching unit 7 which comprises, e.g., two switches SW1, SW2 as shown in FIG. 3.

By means of FIGS. 4 and 5, a possible way of operating the power supply unit 2 is explained. FIG. 4 shows the power supply unit 2 of FIG. 3, illustrating a charging process. For charging energy storing unit 4, SW1 is closed, so as to provide an electric current from energy storing unit 3 via voltage converter 5 to energy storing unit 4. Such a charging current can be, e.g., generally constant. During the time of charging, usually no power is drawn by load 10.

FIG. 5 shows the power supply unit 2 of FIGS. 3 and 4, illustrating the supply of a pulsed current I(t) to load 10, in particular a peak-shaped load. In this case, SW2 is closed, and load 10 can draw a short current pulse corresponding to a fast discharge of energy storing unit 4. The operating conditions and the energy storing unit 4 can be chosen such that energy storing unit 4 is not discharged below 80% or not below 90% of its power capacity. It is possible to operate the power supply unit 2 such that energy storing unit 4 is recharged after each generated current pulse. Slow recharging of rechargable energy storing units is usually preferable because it tends to extend the lifetime of the energy storing unit. For this purpose, it is preferable to provide much more time between successive pulses than one pulse takes, which can be achieved by providing low duty cycles such as 1:100 or lower or 1:1000 or lower.

Accordingly, power supply unit 2 can—controlled by controller 6—be operated such that after each generated pulse (cf. FIG. 5), the energy storing unit 4 is recharged again (cf. FIG. 4), preferably to its full power capacity.

It is, of course, possible to provide power to another load by drawing current from energy storing unit 3 (not shown in FIGS. 3 to 5). E.g., the current drawn during phases B in FIG. 2 could be drawn from energy storing unit 3.

The controller 6 can be used for improving the charging, which can help to increase the lifetime of the rechargeable energy storing unit 4. For this, techniques used in batteries used for today's mobile computers or mobile phones can be used. In particular, it is possible to measure during discharge, the amount of charge that has been provided to the load 10, e.g., 20 mA×1 ms. With this knowledge, it is possible to control the charging process such that exactly the same amount of charge is recharged as has been discharged.

FIG. 7 is a schematical graph of another exemplary load current I(t) as a function of time. For the case that the load is a processor operated in a switched fashion as described above, phases in a first mode are labelled “A”, and phases in said second mode are labelled “B”, analoguously to FIG. 2.

FIG. 8 is a schematical graph of a voltage U′(t) of an energy storing unit with a low internal resistance Ri, when the load current I(t) shown in FIG. 7 is drawn and when charging of the energy storing unit is carried out, e.g., as shown in FIGS. 3 to 5. In FIG. 8, I(t) is indicated using dotted lines. Umin depicts the minimum voltage required for operation of the load (minimum operating voltage).

Due to the internal resistance, the voltage U′(t) provided by the energy storing unit will decrease when drawing the load current. This creates a voltage ripple in U′(t). U′(t) shall not decrease below Umin, because otherwise, the electronic circuit representing the load will not function properly. When no more current is drawn, the energy storing unit will be charged (by another energy storing unit, see, e.g., FIG. 5). Accordingly, U′(t) will rise. Charging will be continued, e.g., until the full power capacity is reached. In FIG. 8, the full power capacity is reached already before the next current pulse is drawn, but as has been indicated before, it can be advisable to time the charging such that the full power capacity is reached approximately immediately before the next current pulse is drawn. Doing this, and providing a very low duty cycle (and, accordingly, recharge very slowly) and discharging the energy storing unit only very little by each current pulse will result in an extremely long lifetime of the energy storing unit in terms of charging-discharging cycles. As has been indicated before, TLB and capacitors are suitable energy storing units for such pulsed operation.

FIG. 9 shows, in a similar fashion as FIG. 8, a schematical graph of a voltage U″(t) of an energy storing unit with a high internal resistance Ri. One problem arising in this case is that the voltage U″(t) provided to the load can, as indicated in FIG. 9, drop below Umin when drawing the current pulse. Accordingly, the energy storing unit cannot ensure a proper operation of the electronic circuit representing the load, the voltage ripple of U″(t) is too large. The power supply is not sufficiently stable for powering the peak-shaped load. And, in addition, the full power of the energy storing unit reached after charging will be remarkably less than the full power the energy storing unit could carry before. Accordingly, the energy storing unit will deteriorate or breakdown soon, i.e. after not very many discharging-charging cycles. A Zn-air battery, for example, is not well suited for such a pulsed operation. But a Zn-air battery has a rather high energy density and can therefore be used in together with a capacitor or thin film battery. The capacitor or thin film battery can be charged by the Zn-air battery and can supply the pulsed load with a sufficiently stable supply voltage.

The invention suggests to deviate from today's concept of handling the power consumption in a hearing device, which aims at avoiding current peaks and at achieving as well as possible a constant direct current consumption. Instead, it is suggested, on the one hand, to provide a particular kind of power supply, which comprises two energy storing units, one of which charging the other, and, on the other hand, to operate a processor of a hearing device on a particular (current peak consuming) way.

### LIST OF REFERENCE SYMBOLS

1 hearing device
2 power supply unit
3 energy storing unit, battery, Zn-air battery
4 energy storing unit, rechargeable battery or capacitor
5 voltage conversion unit, DC/DC converter
6 controller
7 switching unit
8 input unit, microphone arrangement
9 output unit, loudspeaker
10 electronic circuit, load
11 electronic circuit, load, wireless transmitter, wireless receiver, ultra wide band transceiver
12 electronic circuit, load, multitude of memory cells, flash memory unit
13 electronic circuit, load, processor, controller
14 electronic circuit, load, processor, signal processor, DSP
A phase in first operating mode
B phase in second operating mode
I(t),I1(t),I2(t),I3(t),I4(t) current, load current
SW1,SW2 switch
t time
U,U₀,U1,U2,U3,U4 voltage
Umin minimum required voltage for operation of load

1. Hearing device (1) comprising a power supply unit (2), characterized in that said power supply unit (2) comprises a primary energy storing unit (3) and, in addition, a secondary energy storing unit (4), wherein said power supply unit (2) is configured such that said secondary energy storing unit (4) is rechargeable by means of said primary energy storing unit (3).

2. The hearing device (1) according to claim 1, comprising at least one electronic circuit (10;11;12;13;14) supplied with current drawn from said secondary energy storing unit (4).

3. The hearing device (1) according to claim 1 or claim 2, wherein said secondary energy storing unit (4) has a lower internal resistance than said primary energy storing unit (3).

4. The hearing device (1) according to one of the preceding claims, wherein said primary energy storing unit (3) has a higher energy density than said secondary energy storing unit (4).

5. The hearing device (1) according to one of the preceding claims, wherein said power supply unit (2) is configured such that said secondary energy storing unit (4) is recharged before it looses more that 25% of its full charge.

6. The hearing device (1) according to one of the preceding claims, wherein said secondary energy storing unit (4) is a capacitor.

7. The hearing device (1) according to one of the preceding claims, wherein said secondary energy storing unit (4) is a thin-film battery, in particular a thin-film Lithium battery.

8. The hearing device (1) according to one of the preceding claims, wherein said power supply unit (2) comprises a voltage converter (5), and said secondary energy storing unit (4) has a voltage different from, in particular higher than, the voltage of said primary energy storing unit (3).

9. The hearing device (1) according to one of the preceding claims, comprising at least one electronic circuit (10;11;12;13;14), wherein said power supply unit (2) is configured to power said at least one electronic circuit (10;11;12;13;14), and wherein said electronic circuit (10;11;12;13;14) comprises at least one of
a wireless transmitting and/or receiving circuit (11);
a signal processing circuit (14);
a controlling circuit (13);
a memory circuit (11).

10. The hearing device (1) according to one of the preceding claims, comprising at least one electronic circuit (10;11;12;13;14), wherein said power supply unit (2) is configured to power said at least one electronic circuit (10;11;12;13;14), and wherein the current drawn by said at least one electronic circuit (10;11;12;13;14) is a pulsed current.

11. Method for operating a hearing device (1) comprising a power supply unit (2) comprising a primary energy storing unit (3) and, in addition, a secondary energy storing unit (4), said method comprising the step of recharging said secondary energy storing unit (4) by means of said primary energy storing unit (3).

12. The method according to claim 11, comprising the step of supplying at least one electronic circuit (10;11;12;13;14) of said hearing device (1) with current drawn from said secondary energy storing unit (4).

13. The method according to claim 11 or claim 12, wherein said secondary energy storing unit (4) has a lower internal resistance than said primary energy storing unit (3).

14. The method according to one of claims 11 to 13, wherein said primary energy storing unit (3) has a higher energy density than said secondary energy storing unit (4).

15. The method according to one of claims 11 to 14, comprising the step of recharging said secondary energy storing unit (4) before it looses more that 25% of its full charge.

16. The method according to one of claims 11 to 15, wherein said secondary energy storing unit (4) is a capacitor or a thin-film battery, in particular a thin-film Lithium battery.

17. The method according to one of claims 11 to 16, wherein said secondary energy storing unit (4) has a voltage different from, in particular higher than, the voltage of said primary energy storing unit (3), said method comprising the step of converting the voltage of said primary energy storing unit (3) into the voltage of said secondary energy storing unit (4).

18. The method according to one of claims 11 to 17, comprising supplying at least one electronic circuit (10;11;12;13;14) of said hearing device (1) with electric current, wherein said electronic circuit (10;11;12;13;14) comprises at least one of
a wireless transmitting and/or receiving circuit (11);
a signal processing circuit (14);
a controlling circuit (13);
a memory circuit (11).

19. The method according to one of claims 11 to 18, comprising supplying at least one electronic circuit (10;11;12;13;14) of said hearing device (1) with electric current, wherein said electric current is a pulsed current.

20. Power supply unit (2) for a hearing device (1), comprising a primary energy storing unit (3) and, in addition, a secondary energy storing unit (4), wherein said power supply unit (2) is configured such that said secondary energy storing unit (4) is rechargeable by means of said primary energy storing unit (3).

21. Use of a power supply unit (2) comprising a primary energy storing unit (3) and, in addition, a secondary energy storing unit (4), for powering an electronic circuit (10;11;12;13;14) of a hearing device (1), wherein said power supply unit (2) is configured such that said secondary energy storing unit (4) is rechargeable by means of said primary energy storing unit (3).

22. Hearing device (1) comprising at least one processor (10;13;14), which is alternately operated in one of at least two operating modes (A;B), a first (A) of said at least two operating modes being characterized by high processing activity, a second (B) of said at least two operating modes being characterized by low or no processing activity.

23. The hearing device (1) according to claim 22, wherein the hearing device (1) is operated such that said at least one processor (10;13;14) is operated in said first mode (A) for at most 25% of the time, more particularly for at most 15% of the time.

24. The hearing device (1) according to claim 22 or claim 23, wherein the hearing device (1) is operated such that said at least one processor (10;13;14) is operated in said first mode (A) for at most 50 ms before switching to another mode.

25. The hearing device (1) according to one of claims 22 to 24, wherein said at least one processor (10;13;14) is operated such that switching from said first mode to another of said modes occurs generally periodically.

26. The hearing device (1) according to one of claims 22 to 25, wherein said at least one processor (10;13;14) comprises a digital signal processor (14).

27. The hearing device (1) according to one of claims 22 to 26, wherein said at least one processor (10;13;14) comprises a micro-controller (13).

28. Method of operating a hearing device (1) comprising at least one processor (10;13;14), characterized by alternately operating said at least one processor (10;13;14) in one of at least two operating modes (A;B), a first (A) of said at least two operating modes being characterized by high processing activity, a second (B) of said at least two operating modes being characterized by low or no processing activity.

29. The method according to claim 28, wherein said at least one processor (10;13;14) is at least one of
operated in said first mode (A) for at most 10% of the time;
operated in said first mode (A) for at most 50 ms before switching to another mode;
operated such that switching from said first mode (A) to another of said modes occurs generally periodically;
operated such that its current consumption is at least 5 mA when operated in said first mode.

30. The method according to claim 28 or claim 29, wherein said at least one processor (10;13;14) comprises at least one of
a digital signal processor (14);
a micro-controller (13).
